(19) United States
(12) Patent Application Publication
(10) Pub. No.: US 2009/0258117 A1
(43) Pub. Date: Oct. 15, 2009

(54) PIPE MOLD AND PIN-BLOCK ASSEMBLY

(75) Inventors: Kevin Tak Lee, El Sobrante, CA (US); Zeaad Handoush, Pinole, CA (US)

Correspondence Address: GLENN PATENT GROUP, 3475 EDISON WAY, SUITE L, MENLO PARK, CA, 94025, US

(73) Assignee: KZee Novelty Products LLC, El Sobrante, CA (US)

(21) Appl. No.: 12/253,766

(22) Filed: Oct. 17, 2008

Related U.S. Application Data
(63) Continuation-in-part of application No. 12/125,845, filed on May 22, 2008.
Application No. 12/125,845 is a continuation-in-part of application No. 29/306,561, filed on Apr. 10, 2008, now Pat. No. D582094.

(51) Int. Cl. A23G 3/50

(52) U.S. Cl. 426/104; 425/442; 426/514

(57) ABSTRACT

A pipe mold assembly is composed of a mold and a pin block. The mold can be composed of two sides. The bottom side of the mold contains an insert for forming the bowl of the pipe. The insert can be conical shaped and indented to form a lip. A pin block is inserted between the top and bottom sides of the mold to create a smoking channel. The pin block can form a carburetor if the pins are long enough. The pipe is formed by placing the pin block on a flat surface, surrounding the pin block with the mold, and pouring an edible solution into the opening. Once the solution is sufficiently cool, the pin-block and mold are removed.

This application is a continuation-in-part of U.S. patent application Ser. No. 12/125,845, Pipe, filed May 22, 2008, which is a continuation-in-part of U.S. design patent application Ser. No. 29/306,561, Pipe, filed Apr. 10, 2008, the entirety of each of which is incorporated herein by this reference thereto.

### FIELD OF THE INVENTION

Embodiments of this invention relate to a mold for forming a pipe. More particularly, embodiments of this invention relate to a mold and pin-block assembly for forming an edible smoking pipe.

### BACKGROUND OF THE INVENTION

Pipes can be made from a variety of materials, such as wood, ceramic, glass, or even stone. The disadvantage of these materials, however, is that there is a tradeoff between portability and durability. Glass pipes, for example, are lightweight and portable, but also fragile. Conversely, ceramic pipes are durable, but heavy.

An edible pipe is formed using a mold. While most objects created using a mold can be assembled in pieces and attached later, an edible pipe must be composed of one unit. This is because an edible pipe cannot contain any ingredients that would be harmful to the user, e.g. glue. Furthermore, the process of a user eating the pipe might cause the pieces to separate prematurely. It would therefore be advantageous to create a mold for the entire pipe.

The edible pipe requires an air passage between the smoking channel and the bowl so that a user can draw smoke from the bowl to the mouthpiece. The design of an insert to form the smoking channel, however, is problematic because the insert must make contact with the portion of the bowl that forms a mold to create a channel for air flow, but it cannot contact the sides of the mold that form the stem because drawing smoke from the bowl to the mouthpiece requires a closed unit. This problem cannot be solved by forming a solid stem that is later hollowed because any modification to the sugar-based pipe could cause the pipe to crack.

### SUMMARY OF THE INVENTION

In one embodiment, a pipe mold assembly comprises a mold and a pin block assembly. The pin block is used to create a smoking channel in the pipe. The pin can be long enough to form a carburetor or short enough to form a thin layer of sugar on the bowl. The pipe can be made by placing the pin block on a flat surface, opening both sides of the mold, closing the mold around the pins, and pouring the heated solution of sugar into the mold.

### BRIEF DESCRIPTION OF THE DRAWINGS

FIG. 1 is a diagram that illustrates a perspective view of an edible pipe according to one embodiment of the invention;

FIG. 2 is a diagram that illustrates a perspective view of a pipe having a carburetor according to an embodiment of the invention;

FIGS. 3A-3C illustrate a side view (3A), top view (3B), and front view (3C) of a mold according to an embodiment of the invention;

FIGS. 4A-4D illustrate a top view (4A), a front view of the proximal portion (4B), a front view of the distal end (4C), and a side view (4D) of the mold according to an embodiment of the invention;

FIGS. 5A-5C illustrate a bottom view (5A), a side view length-wise (5B), and a side view of the proximal end (5C) of the mold according to an embodiment of the invention;

FIGS. 6A-6D illustrate a top view of the mold and pins (6A), a side view of one embodiment of the pins (6B), a bottom view of the corresponding bottom view of the pins (6C), a side view of another embodiment of the pins (6D), and a corresponding top view of the pins (6E);

FIG. 7 is an example of a mold and pin-block assembly according to an embodiment of the invention;

FIG. 8 is an example of a mold and pin-block assembly where the mold is closed around the pin-block according to an embodiment of the invention; and

FIG. 9 is an example of a mold and pin-block assembly for five pipes according to an embodiment of the invention.

### DESCRIPTION OF THE SPECIFIC EMBODIMENTS

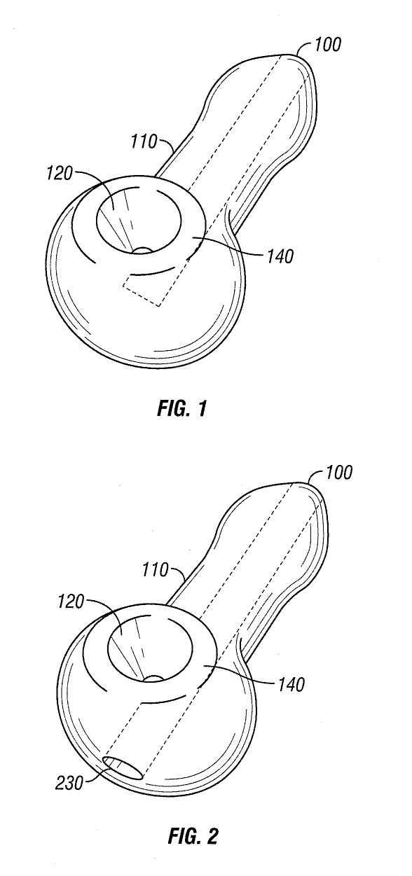

As disclosed in U.S. patent application Ser. No. 12/125,845, and shown in FIGS. 1 and 2, an edible pipe is both durable and lightweight, and has the added benefit of providing flavor to a smokeable material as well as a pleasant taste. Furthermore, when a user no longer desires a functioning pipe, the user can insert a stick into the smoking channel and consume the pipe as if it were a lollipop.

The pipe comprises a mouthpiece 100, a hollow smoking channel 110, and a bowl 120. A user lights smokeable material residing in the bowl 120 and draws air from the bowl 120 through the smoking channel 110 by sucking on the mouthpiece 100. The distal end of the pipe can also form an aperture 230, also known as a carburetor, as shown in FIG. 2. If the pipe forms a carburetor 230, the user draws smoke from the bowl to the mouthpiece 100 by placing a finger on the carburetor 230 to form a closed channel and sucking on the mouthpiece 100.

Mold and Pin-Block Assembly

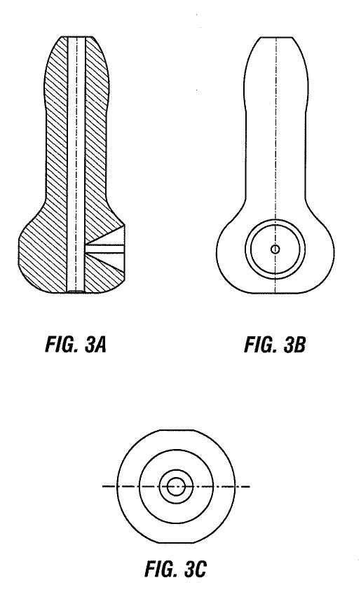

FIG. 3 shows an example of a pipe produced from a mold and pin-block assembly. FIG. 3A, for example, is a side view of the pipe. The distance from the proximal portion to the distal end can be, for example, 86 mm. In this embodiment, the smoking channel forms a carburetor at the distal end. The smoking channel can be, for example, 5.60 mm at the proximal portion and 6.00 mm at the distal end. The hollow channel connects to the bowl, which can form an aperture of, for example, 2.70 mm at the bottom of the cone. The top of the cone can be, for example, 16.61 mm. Those skilled in the art will recognize that these measurements are merely for illustrative purposes only and are not mandatory dimensions.

The insert for the bowl must touch the insert for the smoking channel but, as illustrated in FIG. 3A, the channel can be small, for example, 2.70 mm. The bottom of the bowl is small because, otherwise, the smokeable material can fall into the smoking channel. Once in the smoking channel, the smokeable material can become lodged in the channel or accidentally inhaled by the user.

FIG. 3B shows a top view of the pipe. The smoking channel can have a length of, for example, 20.00 mm. The distance between the center of the bowl and the distal end can be, for example, 15.00 mm.

FIG. 3C shows a front view of the pipe. The diameter of the aperture that forms the mouthpiece can be, for example, 6.00 mm. The diameter of the outside of the mouthpiece can be, for example, 11.00 mm. The diameter of the widest part of the smoking channel can be, for example, 25.00 mm. The diameter of the widest part of the bowl can be, for example, 39.64 mm. The bowl should be thick enough to protect a user's hands from heat produced by burning the smokeable material. Those skilled in the art will recognize that these measurements are merely for illustrative purposes only and are not mandatory dimensions.

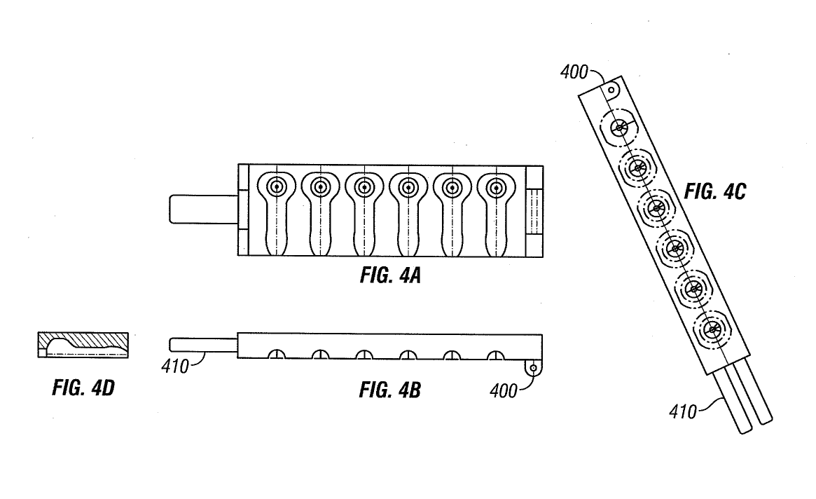

FIG. 4 shows an example of the top part of the pipe mold. FIG. 4A shows a top view of a mold for forming six pipes. The mold can be, for example, 319.00 mm long, including the handle, 94.00 mm wide, and 25.00 mm high. The distance from one center of a pipe to the next center of a pipe can be, for example, 46.00 mm.

FIG. 4B shows a front view of the proximal portion of the mold for the bottom half of the pipe mold. The mold includes a hinge 400 for securing the two mold pieces together, and a handle 410 for opening and closing the mold. FIG. 4C shows a front view of the distal end of both parts of the mold. The top portion of the mold includes conical-shaped portions for forming the bowl. Although the insert for the bowl is depicted in the figures as conical, a person of ordinary skill in the art will recognize that the conical shape is merely one way to design the insert for the bowl. The insert could also take a spherical form, for example, or any other shape as long as it can hold smokeable material and narrows at the bottom to prevent smokeable material from being sucked into the smoking channel. FIG. 4D is a side view of the mold. The bowl is thicker than the smoking channel because the bowl holds smokeable material that can generate enough heat to burn a user's fingers if the bowl is not sufficiently thick.

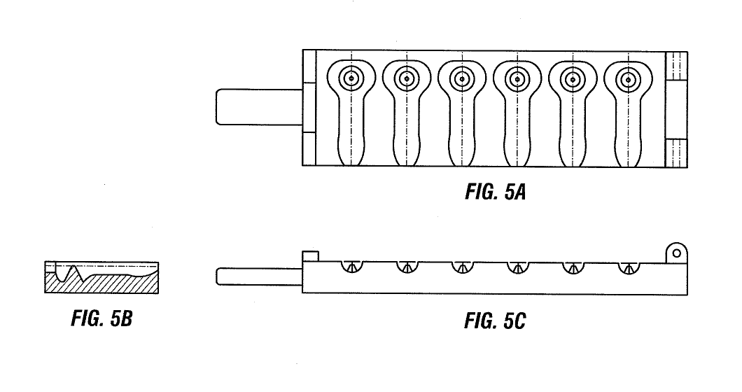

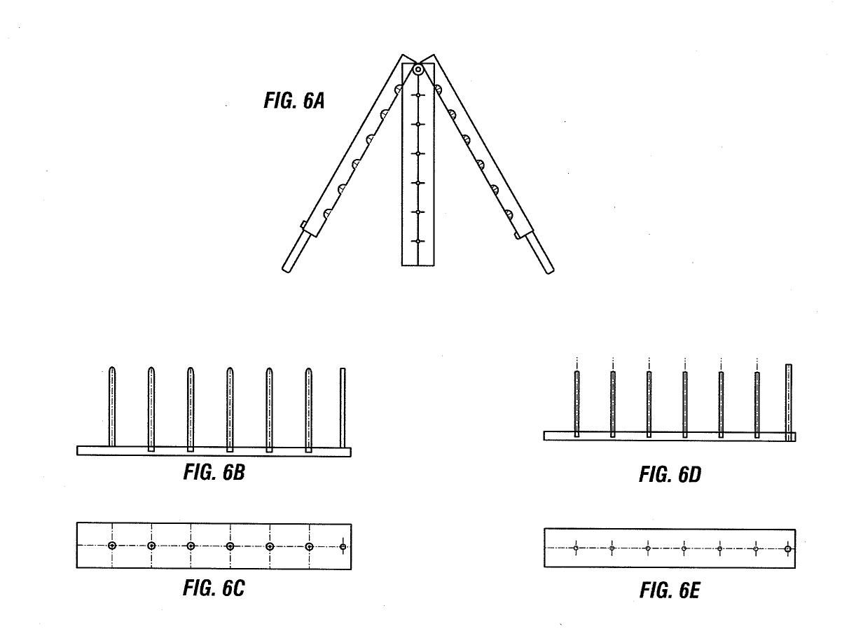

FIG. 5 shows an example of the bottom part of the mold. FIG. 5A shows a top view of the bottom part of the mold. FIG. 5B shows a side view of the bottom part of the mold. The diagonal lines indicate the solid part of the mold, which forms a cone to create a bowl. The cone can be, for example, 18.00 mm in height. The top of the cone can be, for example, 2.70 mm wide. The top should have sufficient width to create a conduit within the pin block (see FIG. 6), thereby allowing air flow between the bowl and smoking channel in the pipe. The cone portion can contain an indentation for forming a lip on the top of the bowl. The lip can be used as a guide for placing smokeable material into the bowl or for securing a screen in the bowl.

FIG. 5C shows a front view of the proximal portion of the mold. The top and bottom parts of the mold should be properly aligned. For example, if the bottom mold curves upward at the proximal portion, the top mold should curve upward at the same points. Otherwise, the pipe may be difficult to hold, smoke, or even fail to form a sealed chamber.

To form the smoking channel, a block containing pins is inserted between the space created by the mold. FIG. 6 shows an example of two embodiments of the pin block. FIG. 6A shows a top view of the mold and the pin block. The mold is closed around the pin block. FIG. 6B shows an example of a side view of the pin block. In one embodiment, the pins are substantially flush with the distal end of the mold, which creates a pipe having a carburetor. The height from the bottom of the block to the top of the pins can be, for example, 103.00 mm. The height from the base of the pins to the top of the pins can be 93.00 mm. In one embodiment of the invention, the pins form a tapered top. The diameter of the widest point of the pins can be, for example, 6.00 mm. The diameter for the tapered part of the pin can be, for example, 2.60 mm. FIG. 6C shows a top view of the pin block.

In another embodiment, the pins are not of sufficient length to form a carburetor. Thus, the bowl does not contain an aperture. The pins are long enough, however, that a thin layer of sugar partially or completely covers the bowl. A user can, optionally, remove the thin layer of sugar to form a pipe with a bowl having a carburetor by breaking through the sugar layer with a small sharp object, such as a knife, scissors, or a straw. FIG. 6D shows a side view of pins that are not long enough to form a carburetor. The pins can be, for example, 98.70 mm from the bottom of the block to the top of the pin. FIG. 6E is a top view of a pin-block that is long enough to form a thin layer of sugar in front of the carburetor.

The measurements described in this application are merely used for illustrative purposes. A person of ordinary skill in the art will understand that the mold can contain a pipe that is bigger or smaller with different dimensions and a different number of pipes per mold.

Example for Making an Edible Pipe

The pipe can be composed of an edible material having 59.6% sugar, 36.15% glucose syrup, 2.95% water, 0.3%. flavoring, and 1% lactic acid. The pipe is made by dissolving the sugar, syrup, and water together at 30 to 35° C., stirring frequently to form a solution. The solution is then heated to 150° C., which causes the solution to boil. This step takes place in a vacuum with pressure of 0.02 MPa. The sugar is heated to between 146-154° C., which causes most of the water in the solution to evaporate and leaves a thick syrup. Next, lactic acid and flavoring can be mixed into the solution.

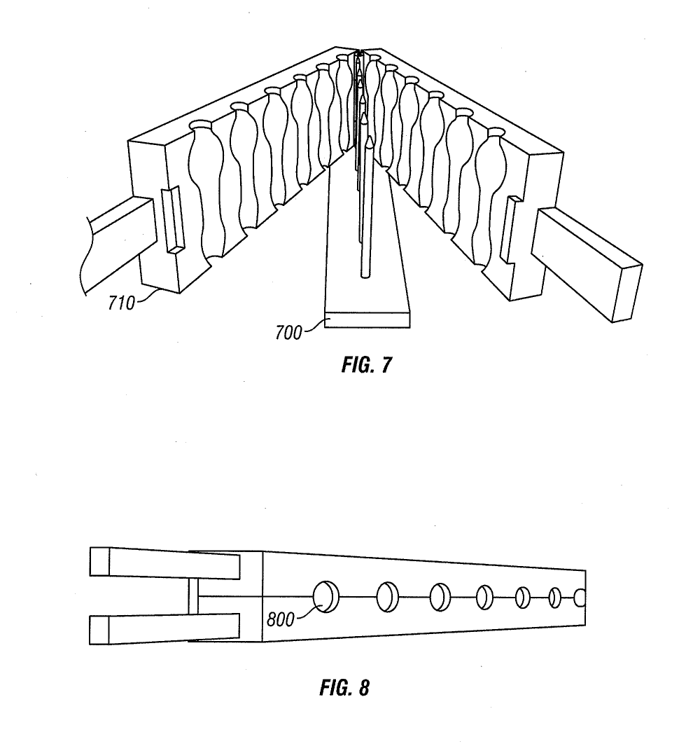

FIG. 7 shows an example of a mold and pin-block assembly for creating six pipes according to one embodiment of the invention. The pin block 700 is placed on a flat surface. The mold 710 is opened by grasping the handles 410. The mold is placed around the pins.

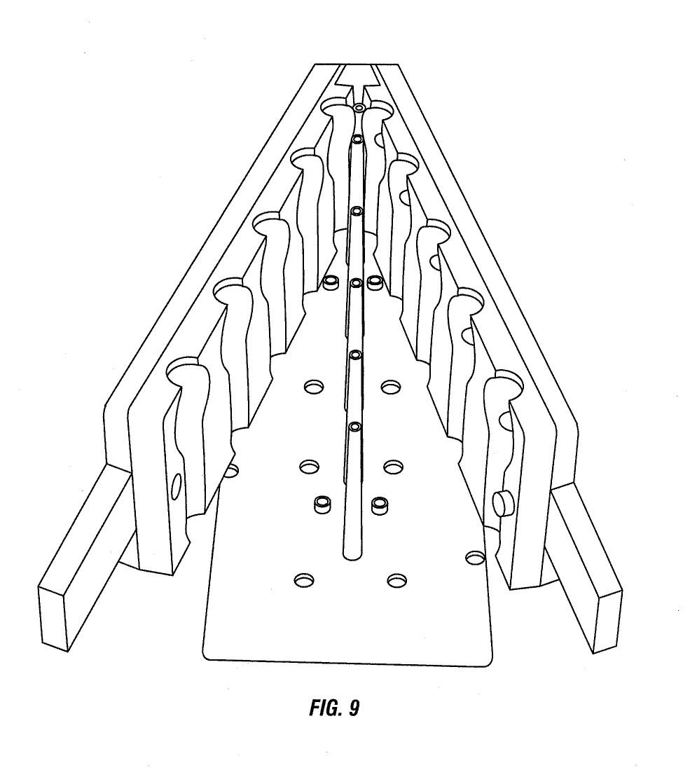

FIG. 8 shows an example of a top view of a mold and pin-block assembly where the mold is closed. The top of the pins 800 are visible.

FIG. 9 shows an example of a mold and pin-block assembly for creating five pipes according to another embodiment of the invention.

Once the ingredients are equally distributed, the solution is poured through the top of the mold and pin-block assembly. This step can be automated or done by hand.

The mold and pin-block assembly is placed in a cooling channel to lower the temperature of the pipe to between 18° and 25° C. with 45% humidity. During the de-molding stage, the temperature is raised to between 35° and 45° C. The pipe is removed from the mold once the solution hardens, e.g. 30 minutes. The pipe cannot be removed before the solution has sufficiently cooled. Otherwise, the pipe may not maintain its intended shape and may break. During removal, the pipe must be removed slowly from the mold to prevent the pipe from breaking or cracking. The pipes are screened for metal before shipping. The pipe is stored, for example, in a room with a temperature between 20° and 28° C. and humidity of less than 45%.

Although this example describes using a sugar solution to form an edible pipe, a person of ordinary skill in the art will understand that the mold and pin-block assembly can be used to create a pipe made from other materials that are also edible, e.g. cornstarch, corn syrup, or non-edible, e.g. plastic, rubber, glass, etc.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A pipe mold assembly, comprising:
a pipe mold having a proximal portion and a distal portion, said proximal portion corresponding to a front part of a pipe, said pipe mold comprising:
a top block having an upper portion, a lower portion, and a center, said upper portion forming an indentation that slopes downward at said proximal portion to form a mouthpiece of said pipe, said indentation sloping downward in said center to form a smoking channel for said pipe, said indentation curving slightly upwards and then sharply downwards to touch said lower portion of said top block, and curving sharply upwards to said distal portion of said top block; and
a bottom block having an upper portion and a lower portion, said upper portion forming a substantially curved indentation upwards at said proximal portion of said bottom block, said lower portion curving slightly upwards and then slightly downwards before said indentation of said top block curves sharply downward, and curving slightly upwards at said distal portion of said bottom block;
wherein said top block is removably attached to said bottom block;
wherein said top block and bottom block are substantially aligned; and
a pin block comprising:
a base; and
at least one pin attached to said base, said pin being long enough to touch said lower portion of said top block of said mold to form a conduit, said pin only touching said sharply curved downward indentation when inserted between said top block and said bottom block of said mold;
wherein said pins are arranged in said pin block for insertion between a space formed in said mold, thereby creating said smoking channel in said pipe.

2. The pipe mold assembly of claim 1, wherein said at least one pin is substantially flush with said distal portion of said mold, thereby defining an aperture when said pipe is formed from said pipe mold assembly.

3. The pipe mold assembly of claim 1, wherein said at least one pin has a length that reaches almost to said distal portion of said pipe mold to create at least a partially covered portion of said bowl of said pipe.

4. The pipe mold assembly of claim 1, wherein said pipe mold comprises a plurality of molds for a plurality of pipes and said pin block comprises a plurality of pins.

5. The pipe mold assembly of claim 1, wherein said sharply curving indentations of said upper block form a conical-shaped indentation.

6. The pipe mold assembly of claim 1, wherein said sharply curving indentations of said upper block form a spherical-shaped indentation.

7. The pipe mold assembly of claim 1, wherein said upper block and said lower block of said mold further comprise handles.

8. The pipe mold assembly of claim 1, wherein said upper block and said lower block of said mold are removably joined with a pin.

9. The pipe mold assembly of claim 1, wherein said indentation for forming said bowl is indented to form a lip.

10. A method of producing an edible pipe from a pipe mold assembly, the method comprising the steps of:
placing a pin block having at least one pin on a flat surface;
surrounding said pin block with a top block and a bottom block of a mold, wherein said at least one pin on said pin block is substantially centered in between said top and said bottom block of said mold;
pouring a solution of edible material into said mold;
opening said top and said bottom block of said mold after said solution becomes solid; and
removing said pin block from said pipe.

11. The method of claim 10, wherein said solution of edible materials comprises sugar, glucose syrup, water, flavoring, and lactic acid.

12. The method of claim 10, wherein said solution is heated to at least 150° C.

13. The method of claim 10, further comprising the step of:
exposing said pipe mold assembly to a temperature between 18° and 25° C. with 45% humidity after said solution of edible material is poured into said mold.

14. The method of claim 10, wherein said steps are carried out in a vacuum.

15. The method of claim 10, wherein said edible material comprises cornstarch and corn syrup.

16. The method of claim 10, wherein said opening of said top and said bottom block of said mold is achieved by using a pair of handles on said mold.

17. The method of claim 10, further comprising the step of:
forming a solution of sugar, syrup, and water at 30 to 35° C.

18. An edible pipe made by the steps of:
placing a pin block having at least one pin on a flat surface;
surrounding said pin block with a top and bottom block of a mold, wherein said at least one pin on said pin block is substantially centered in between said top and said bottom block of said mold;
pouring a solution of edible material into said mold;
opening said top block and said bottom block of said mold after said solution solidifies; and
removing said pin block from said pipe.

19. The edible pipe of claim 18, wherein the steps further comprise:
forming a solution of sugar, syrup, and water at 30° to 35° C.

20. A pipe formed using the mold of claim 1.
